(19) United States
(12) Patent Application Publication
(10) Pub. No.: US 2013/0061884 A1
(43) Pub. Date: Mar. 14, 2013

(54) METHOD FOR CLEANING WAFER AFTER CHEMICAL MECHANICAL PLANARIZATION

(71) Applicants: Tao Yang, Beijing (CN); Chao Zhao, Kessel-Lo (BE); Junfeng Li, Beijing (CN)

(72) Inventors: Tao Yang, Beijing (CN); Chao Zhao, Kessel-Lo (BE); Junfeng Li, Beijing (CN)

(73) Assignee: Institute of Microelectronics, Chinese Academy of Sciences, Beijing (CN)

(21) Appl. No.: 13/641,874

(22) PCT Filed: Mar. 23, 2012
(86) PCT No.: PCT/CN2012/072982

§ 371 Date: Oct. 18, 2012

(30) Foreign Application Priority Data
Jun. 3, 2011 (CN) 201110149721.5

(51) Int. Cl. B08B 3/04

(52) U.S. Cl. 134/26

(57) ABSTRACT

A method for cleaning wafer after chemical mechanical planarization that includes placing the wafer in the wafer holder and rotating the wafer holder and the wafer simultaneously, cleaning with chemicals by providing the wafer surface with chemical detergent through the detergent supply cantilever that keeps a certain distance away from the wafer surface, cleaning with deionized water by providing the wafer surface with deionized water through the detergent supply cantilever to remove the chemical detergent and cleaning products. The method also includes the second clean for better cleaning effect and drying the wafer out. According to the wafer cleaning method, the non-contact detergent and deionized water supply cantilever used for wafer cleaning reduces or eliminates the possible problems in making macro scratches on wafer surface in the scrubbing process and increases the yield for wafer devices.

### CROSS REFERENCE TO RELATED APPLICATIONS

This application is a National Phase application of, and claims priority to, PCT Application No. PCT/CN2012/072982, filed on Mar. 23, 2012, entitled “METHOD FOR CLEANING WAFER AFTER CHEMICAL MECHANICAL PLANARIZATION”, which claims priority to the Chinese Patent Application No. 201110149721.5, filed on Jun. 3, 2011. Both the PCT Application and Chinese Application are incorporated herein by reference in their entireties.

### TECHNICAL FIELD

The present disclosure relates to a method for manufacturing semiconductor devices, and in particular, to a method for cleaning wafer after chemical mechanical planarization.

### BACKGROUND

Chemical mechanical planarization (CMP) has become the key technology for improvement in integrated circuit technology after continuous practice and development since it has been introduced into the integrated circuit manufacturing process in 1990. Currently CMP has been widely used in the planarization processes of shallow trench isolation (STI), oxides (such as interlayer dielectric (ILD)), tungsten-plug (W-plug), and copper interconnection, and so on. CMP is an advanced process with wafer dry-in and dry-out, and can be divided into chemical mechanical planarization and the consequent cleaning techniques according to the different process in wafer treatment. In the process of chemical mechanical planarization, the oxide particles in the grinding slurry and the grinding products will be adsorbed on the surface of the wafer. Although most of the grinding slurry and the grinding products can be removed by the rotation of the polishing head and polishing pad and by the radial linear motion of the polishing head relative to the center of the polishing pad, there will still be a large quantity of remaining grinding slurry and products adsorbed on the wafer surface at the end of the CMP process. If not cleaned in time these particles will be condensed at the wafer surface and cannot be removed effectively lately. Therefore, the cleaning process after CMP is very important for increasing the wafer yield.

The cleaning after CMP in current CMP process devices involves in a two-step process, both using a contact mode for wafer cleaning. There are two types of contact modes for wafer cleaning, as given in FIGS. 1 and 2. The first step of cleaning is to use a pair of PVA rolling brushes (shown as the gridded rectangle in FIG. 1) to embed the wafer (shown as the black rectangle in FIG. 1). Wafer could be placed either horizontally or vertically. The cleaning could be done simultaneously on the surface and back of the wafer. In the cleaning process, different chemical detergent followed by deionized water can be added through the supply pipelines (gray rectangle in FIG. 1) directed by the arrows near the top and bottom surface of the wafer. In the second step, contact mode is also used for cleaning the wafer, by utilizing either the PVA rolling brushes or the Pencile brushes to brush scrub the wafer. Pencile is a type of brush for brush scrubbing the wafer in contact mode, as given in FIG. 2. The Pencile brush scrubs the wafer back and forth through brush head with certain contact area to make the cleaning. At this point the wafer is placed horizontally, with deionized water added into the back of the wafer for cleaning. In the second step of cleaning in contact mode, different chemical detergent followed by deionized water should be chosen as needed in different process for better cleaning effect. After these two steps of cleaning, dry the wafer out and finish the cleaning procedure after CMP.

The first step of cleaning is very important because wherein most grinding slurry and product particles remaining on the wafer surface will be removed. In the first step of cleaning with PVC rolling brushes, the brushes scrub with rotation relative to the wafer and the wafer needs to scroll with a fixed center in order for the whole surface to be cleaned. For better cleaning effect, a certain contact with pressures needs to be kept between the rolling brushes and the surface and back of the wafer. If large-sized grinding slurry abrasives or product particles are left over on the wafer surface, or stiff particles are contaminated or crystallized on the brush surface after CMP process, macro scratches will be made on the wafer surface in the first step of cleaning, resulting in a decreased yield for wafer devices.

In summary, all currently available first-step cleaning process in contact mode after CMP will cause potential problems in making macro scratches on wafer surface.

### SUMMARY OF THE DISCLOSURE

Therefore, the purpose of the present disclosure is to provide a method for cleaning wafer with non-contact of the rolling brushes in replace of the currently used first-step cleaning process with PVC rolling brushes in contact mode after CMP, in order to reduce or eliminate the problems in making macro scratches on wafer surface in the scrubbing process.

The main idea is to clean the wafer with non-contact of the rolling brushes in the first stage of wafer cleaning after CMP, in replace of the currently used cleaning process with PVA rolling brushes in contact mode to eliminate the macro scratches on wafer surface in the scrubbing process. In the second stage, non-contact of the rolling brushes or with PVA rolling brushes or Penile brushes are used for better cleaning effect, as needed in different process for better cleaning effect.

Specifically, the present disclosure provides a method for cleaning wafer after chemical mechanical planarization, comprising: step A, placing the wafer in the wafer holder; step B, driving the wafer rotation member to rotate the wafer holder and the wafer simultaneously; step C, cleaning with chemicals by providing the wafer surface with chemical detergent through the detergent supply cantilever, which keeps a certain distance away from the wafer surface; step D, cleaning with deionized water by providing the wafer surface with deionized water through the detergent supply cantilever to remove the chemical detergent and cleaning products; step E, repeating the second-stage cleaning operation for better cleaning effect; and step F, drying the wafer out.

In step A the wafer is fixed in the wafer holder by a mechanical clamp and/or by a Bernoulli cushion clamp.

In steps C and/or D, pressurized gas or acoustic wave is imposed in chemical detergent or deionized water for better cleaning effect. The pressurized gas is air or nitrogen and the spray speed of chemical detergent is 1˜8 m/s. The acoustic wave is megasonic wave.

Step C also includes providing to the back of the wafer with chemical detergent or deionized water through the internal pipelines in the wafer rotation part.

The chemical detergent comprises ammonia water, organic citric acid, hydrogen peroxide, hydrochloric acid, Carols acid, hydrofluoric acid, nitric acid, choline, trimethyl (2-hydroxy-methyl) ammonium hydroxide, Ozone water, sulfuric acid or combinations thereof.

After step D the second stage of cleaning is carried out. In the second stage a similar method as step C for cleaning the wafer with non-contact of the rolling brushes or with PVA rolling brushes or Pencile brushes is used, as needed, for better cleaning effect.

According to the wafer cleaning method described in the present disclosure, it is due to the non-contact detergent and deionized water supply cantilever in use for wafer cleaning that reduces or eliminates the possible problems in making macro scratches on wafer surface in the scrubbing process, and thus increases the yield for wafer devices.

The objects listed in the present disclosure and the other objects not listed herein are achieved within the independent claim in the present application. Examples of the present disclosure are set in the independent claim, and special features are set in dependent claims thereof.

### BRIEF DESCRIPTION OF THE DRAWINGS

The technical solutions of the present disclosure are described in details in reference to the following figures:

FIG. 1 shows the schematic diagram of the wafer scrubbing with PVA rolling brushes in the prior art;

FIG. 2 shows the schematic diagram of the wafer scrubbing with Pencile brushes in the prior art; and

FIG. 3 shows the schematic diagram of the single non-contact wafer cleaning device according to the present disclosure.

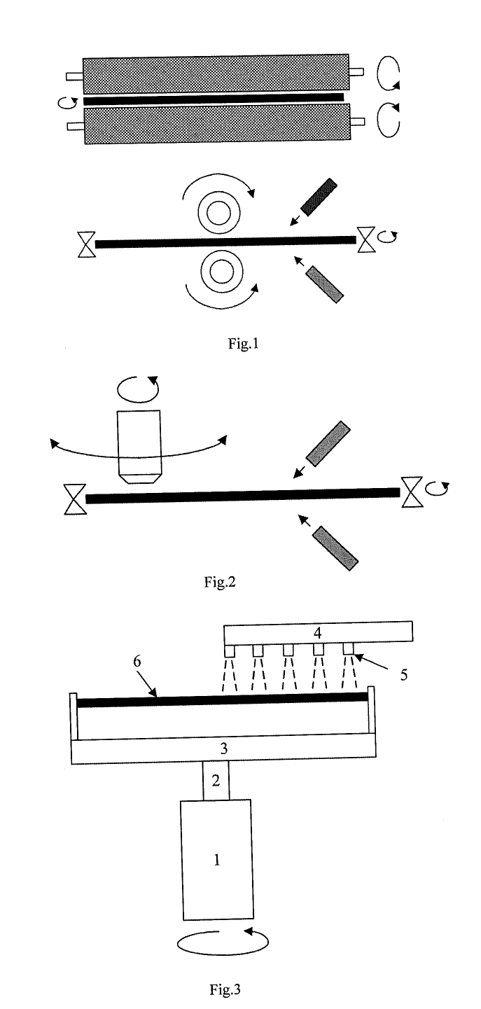

### REFERENCE NUMERALS

1. Base stage
2. Wafer rotation part
3. Wafer holder
4. Detergent supply cantilever
5. Nozzle
6. Wafer

### DETAILED DESCRIPTION

Exemplary embodiments of the present disclosure will be described in more details below with reference to the accompanying drawings, to illustrate the features and effects of the technical solutions of the present disclosure. The method is disclosed. It should be noted that similar reference numerals denote similar member in the drawings. The terms “first”, “second”, “above”, “below”, etc. can be used to describe all device members or process stages. The description does not imply the space, order, or hierarchical relationship between the descriptive device members or process stages unless otherwise indicated.

FIG. 3 illustrates the schematic diagram of the single non-contact wafer cleaning device according to the present disclosure comprising base stage 1, wafer rotation part 2, wafer holder 3, and detergent supply cantilever 4, etc. The base stage 1 is fixed inside the cleaning module of CMP device for supporting the above wafer rotation part 2. The wafer rotation part 2 is mechanically coupled stretchable to the base stage 1 such as through bearing. The wafer rotation part 2 and/or base stage 1 contains a drive motor (not shown), which makes the wafer rotation part 2 rotate around the vertical axis of the base stage 1. The wafer holder 3 is mechanically coupled to the wafer rotation part 2 such as through bolts or slot, so that the wafer holder 3 and the wafer 6 on it will rotate simultaneously when the wafer rotation part 2 is driven to rotate by the drive motor. The wafer holder 3 is used to fix and hold the wafer 6 to be cleaned after CMP by a Bernoulli cushion clamp and/or by a mechanical clamp such as a slot or flange clamp. The detergent supply cantilever 4 is above wafer holder 3, keeping a certain distance from the wafer holder 3 and the wafer 6. In the lower surface of the detergent supply cantilever 4, there are multiple nozzles 5 to provide detergent. Preferable, multiple nozzles 5 are equidistant for evenly cleaning. Although the detergent supply cantilever 4 is only fixed on one side of the wafer holder 3 in FIG. 3, the horizontal and vertical distance between them and the setting modes can be adjusted reasonably as needed. For example, the length of the detergent supply cantilever 4 equals that of the wafer holder 3 and it is set fixed to non-rotatable, or the length of the detergent supply cantilever 4 is one half the length of the wafer holder 3 and it is set to rotatable around the vertical axis of the base stage 1 through additional rotation part (not shown), or the detergent supply cantilever 4 is set as close as possible to the wafer holder 3 to reduce the waste of detergent. The detergent supply cantilever 4 controlled by an external control system (not shown) provides different detergent to the surface of wafer 6 at different time period according to different process, the detailed method of which is described below.

The method for cleaning wafer according to the present disclosure comprises the following steps:

First, step A, placing the wafer in the wafer holder. Place the surface of wafer 6 which is treated by the CMP process in advance (i.e. the side on which forms the semiconducting device structure) upward in the wafer holder 3 by a mechanical clamp, then fix the edge of wafer 6 by the wafer holder 3.

Second, step B, driving the wafer rotation part to rotate the wafer holder and the wafer simultaneously. It can be driven by the internal drive motor in the base stage 1 or by the internal drive motor in the wafer holder 2, or by rotation of both parts simultaneously to speed up and reduce time cost.

Third, step C, first cleaning with chemicals by providing the wafer surface with chemical detergent through the detergent supply cantilever. Specifically, spray detergent from multiple nozzles 5 simultaneously on the detergent supply cantilever 4 with rotation of the wafer 6 to clean the wafer surface. The chemical detergent in use is chosen according to the object materials in CMP, such as ammonia water, organic citric acid, hydrogen peroxide, hydrochloric acid, Carols acid, hydrofluoric acid, nitric acid, choline, trimethyl (2-hydroxy-methyl) ammonium hydroxide, Ozone water, sulfuric acid or combinations thereof, the formulation of which is determined by the chemicals and speed for cleaning. The detergent can be supercritical fluids such as mixture of acrylic acid and 5% carbon dioxide by volume. In order for better cleaning effect to remove small particles, air or nitrogen can be pressurized to the detergent supply cantilever 4 through additional gas storage slot or gas pipeline. Furthermore, additional acoustic wave device can be added into the detergent supply system to enhance the cleaning effect to remove particles by using ultrasonic (20˜800 kHz) or megasonic (over 800 kHz) wave. The spray speed for detergent should be set according to the wafer size, the distance between nozzle and wafer, the thickness of fluid boundary layer and the cleaning effect, such as to be 1˜8 m/s, specifically 4 m/s. The chemical cleaning can be done not only from the front side of the wafer 6 through the nozzle 5 in the detergent supply cantilever 4, but also from the back side of the wafer through the additional detergent supply pipeline (not shown) inside the wafer holder 2. The detergent can be the same chemical detergent with pressurized gas or acoustic wave as used in front side cleaning, or deionized water with pressurized gas or acoustic wave.

Continuously, step D, first cleaning with deionized water by providing the wafer surface with deionized water through the detergent supply cantilever to remove the chemical detergent and cleaning products. Similar as in step C, pressurized gas or acoustic wave can be applied to the deionized water to spray with high speed to the wafer surface for better cleaning effect.

Step E after step D, second cleaning with chemicals. It can be carried out using a similar wafer cleaning device with non-contact of the rolling brushes as in step C given in FIG. 3, which is providing the wafer surface with chemical detergent through the detergent supply cantilever, or using similar PVA rolling brushes or Pencile brushes as in conventional CMP.

Last, step F, drying the wafer out. For example, air or nitrogen can be flowed to the surface of wafer 6, or wafer can be parched at a certain low temperature.

According to the wafer cleaning method described in the present disclosure, it is due to the non-contact detergent and deionized water supply cantilever in use for wafer cleaning that reduces or eliminates the possible problems in making macro scratches on wafer surface in the scrubbing process, and thus increases the yield for wafer devices.

Although the invention has been already illustrated according to the above one or more examples, it will be appreciated that numerous modifications and embodiments may be devised by the skilled in the art without deviating the scope of the invention. Furthermore, it may be devised from the teaches of the disclosure changes suitable for special situation or materials without deviating the scope of the invention. Therefore, objects of the disclosure are not limited to special examples for preferred embodiments, meanwhile structure of the device and manufacture method thereof cover all embodiments fall into the scope of the invention.

1. A method for cleaning wafer after chemical mechanical planarization, comprising:
Step A, placing the wafer in the wafer holder;
Step B, driving the wafer rotation part to rotate the wafer holder and the wafer simultaneously;
Step C, first cleaning with chemicals by providing the wafer surface with chemical detergent through the detergent supply cantilever, which keeps a certain distance away from the wafer surface;
Step D, first cleaning with deionized water by providing the wafer surface with deionized water through the detergent supply cantilever to remove the chemical detergent and cleaning products;
Step E, second cleaning for better cleaning effect; and
Step F, drying the wafer out.

2. The method according to claim 1, wherein in step A the wafer is fixed in the wafer holder by a mechanical clamp and/or by a Bernoulli cushion clamp.

3. The method according to claim 1, wherein in steps C and/or D pressurized gas or acoustic wave is imposed in chemical detergent or deionized water for better cleaning effect.

4. The method according to claim 3, wherein the pressurized gas is air or nitrogen and the spray speed of chemical detergent is 1˜8 m/s.

5. The method according to claim 3, wherein the acoustic wave is megasonic wave.

6. The method according to claim 1, wherein step C also includes providing the back of the wafer with chemical detergent or deionized water through the internal pipelines in the wafer rotation part.

7. The method according to claim 1, wherein the chemical detergent comprises ammonia water, organic citric acid, hydrogen peroxide, hydrochloric acid, Carols acid, hydrofluoric acid, nitric acid, choline, trimethyl (2-hydroxy-methyl) ammonium hydroxide, Ozone water, sulfuric acid or combinations thereof.

8. The method according to claim 1, wherein in the second clean a similar wafer cleaning method as in step C with non-contact of the rolling brushes is used.

9. The method according to claim 8, wherein in the second clean a wafer cleaning method with PVA rolling brushes or Pencile brushes is used.
